(19) United States
(12) Patent Application Publication
(10) Pub. No.: US 2021/0158842 A1
(43) Pub. Date: May 27, 2021

(54) METHOD FOR CONTROLLING VIDEO EDITING DEVICE, VIDEO EDITING DEVICE, AND PROGRAM

(71) Applicant: SEIKO EPSON CORPORATION, Tokyo (JP)

(72) Inventor: Kentaro IDE, Shiojiri-shi (JP)

(21) Appl. No.: 17/104,586

(22) Filed: Nov. 25, 2020

(30) Foreign Application Priority Data
Nov. 27, 2019 (JP) 2019-214119

(51) Int. Cl. G11B 27/031; H04N 9/31

(52) U.S. Cl. CPC G11B 27/031; H04N 9/3188

(57) ABSTRACT

An information processing device functioning as a video editing device editing a video to be projected by a projector includes a display control unit, an acquisition unit, and a decision unit. The display control unit causes a display device of a touch panel to display an editing screen including a video display area where a video to be projected by a projector is displayed. The acquisition unit acquires, from the projector, information representing an aspect ratio of a projected video projected by the projector. The decision snit decides the video display area according to the aspect ratio represented by the information acquired by the acquisition unit.

The present application is based on, and claims priority from JP Application Serial Number 2019-214119, filed Nov. 27, 2019, the disclosure of which is hereby incorporated by reference herein in its entirety.

### BACKGROUND

### 1. Technical Field

The present disclosure relates to a method for controlling a video editing device, a video editing device, and a program.

### 2. Related Art

WO2009/020103 discloses an interface system for editing video data representing a video, using a computer. JP-A-2009-151698 discloses a photographing and printing device that takes a photograph, combines the photograph with a background image or the like, and outputs the photograph combined with the background image in the form of a printed sticker. JP-A-2009-151698 also discloses a technique used in a service transmitting an image composed by the photographing and printing device to a mobile terminal such as a mobile phone and configured to prevent generation of a blank space due to a difference in aspect ratio between the image composed by the photographing and printing device and the display screen of the mobile phone. In the technique disclosed in JP-A-2009-151698, the photographing and printing device acquires the aspect ratio of the display screen of the mobile phone via a server and causes a screen during editing and an image for transmission to reflect the acquired aspect ratio.

The related-art techniques have a problem in that the device as the destination of output of a video cannot edit the video while checking the video with the actual output aspect ratio and therefore an output result as intended by the user may not be provided.

### SUMMARY

A method for controlling a video editing device according to an aspect of the present disclosure is a method for controlling a video editing device editing a video to be projected by a projector. The method includes: displaying an editing screen including a video display area where an editing target video is displayed; acquiring, from the projector, information representing an aspect ratio of a projected video projected by the projector; and deciding the video display area according to the aspect ratio represented by the information.

A video editing device according to another aspect of the present disclosure includes: a display control unit causing an editing screen to be displayed, the editing screen including a video display area where a video to be projected by a projector is displayed; an acquisition unit acquiring, from the projector, information representing an aspect ratio of a projected video projected by the projector; and a decision unit deciding the video display area according to the aspect ratio represented by the information acquired by the acquisition unit.

A non-transitory computer-readable storage medium according to still another aspect of the present disclosure stores a program. The program causes a computer to function as: a display control unit causing an editing screen to be displayed, the editing screen including a video display area where a video to be projected by a projector is displayed; an acquisition unit acquiring, from the projector, information representing an aspect ratio of a projected video projected by the projector; and a decision unit deciding the video display area according to the aspect ratio represented by the information acquired by the acquisition unit.

### BRIEF DESCRIPTION OF THE DRAWINGS

FIG. 1 shows an information processing device 1 according to an embodiment of the present disclosure.

FIG. 2 shows a configuration example of the information processing device 1.

FIG. 3 shows an example of an editing screen which a processing device 40 in the information processing device 1 causes a display device of a touch panel 10 to display.

FIG. 4 shows another example of the editing screen which the processing device 40 in the information processing device 1 causes the display device of the touch panel 10 to display.

FIG. 5 shows a display example where a mask and an object overlap each other.

FIG. 6 is a flowchart showing a flow of a control method executed by the processing device 40 in the information processing device 1 according to a program P.

FIG. 7 shows another display example where a mask and an object overlap each other.

FIG. 8 shows still another display example where a mask and an object overlap each other.

### DESCRIPTION OF EXEMPLARY EMBODIMENTS

An embodiment of the present disclosure will now be described with reference to the drawings. The embodiment described below includes various technically preferable limitations. However, the embodiment of the present disclosure is not limited to the form described below.

### 1. Embodiment

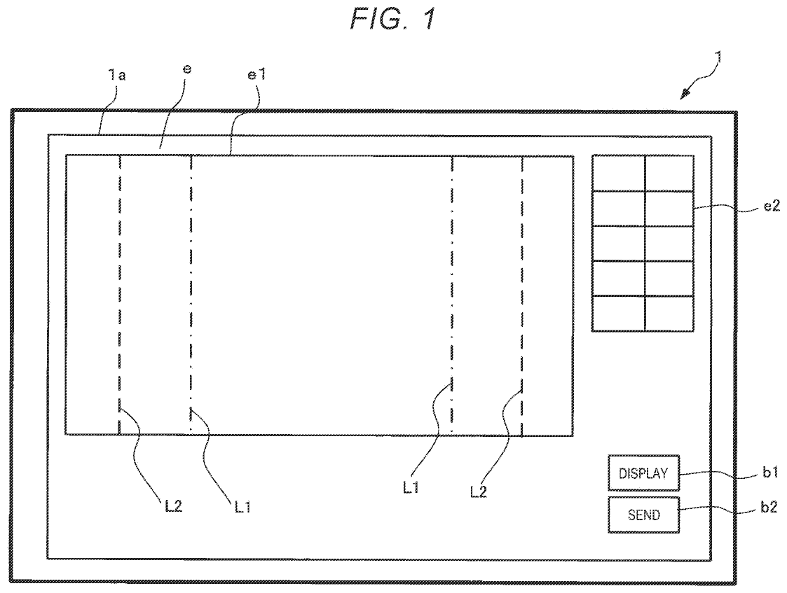

FIG. 1 shows an information processing device 1 according to an embodiment of the present disclosure. In FIG. 1, a smartphone is shown as an example of the information processing device 1. The information processing device 1 is not limited to a smartphone. The information processing device 1 maybe, for example, a PC (personal computer) or tablet terminal.

The information processing device 1 includes a display surface 1a displaying various images. The display surface 1a shown in FIG. 1 displays an editing screen e for editing a video. The information processing device 1 generates video data representing a video, based on an operation on the display surface 1a.

The video represented by the video data generated by the information processing device 1 is repeatedly displayed, for example, by a projector. The video repeatedly displayed by the projector is used, for example, for a product advertisement or for a light effect to create a certain impression of a product.

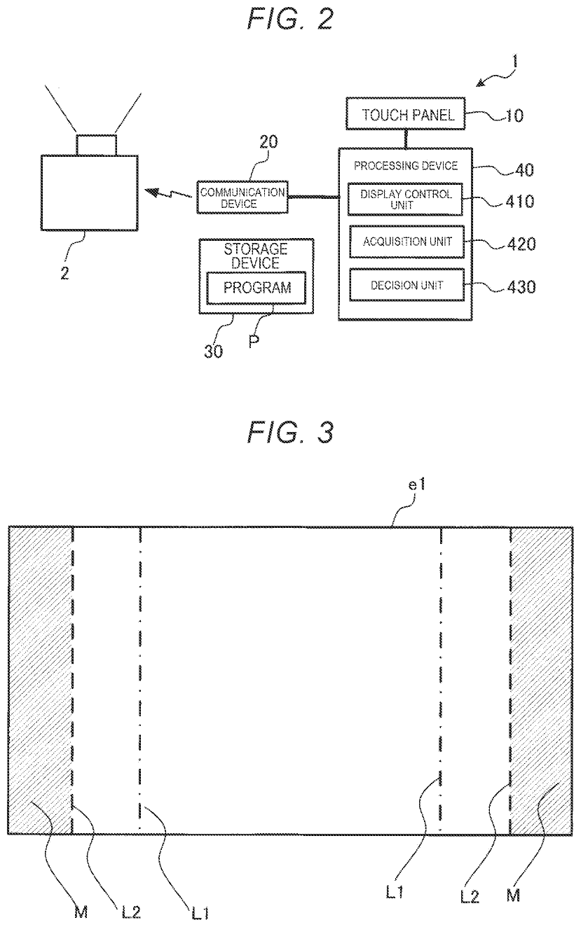

FIG. 2 shows an example of the information processing device 1. The information processing device 1 includes a touch panel 10, a communication device 20, a storage device 30, and a processing device 40.

The touch panel 10 is a device in which a display device and an input device accepting an operation by a user are integrated together. The touch panel 10 includes the display surface 1a. The touch panel 10 displays various images on the display surface 1a. The touch panel 10 detects a touch position, using an electrostatic capacitance specified by an object in contact with the touch panel 10 and the touch panel 10.

The communication device 20 communicates with various devices. The communication device 20 communicates, for example, with a projector 2 via a wireless LAN (local area network). The communication device 20 may communicate with a device such as the projector 2 via a different communication form from wireless LAN. A specific example of the different communication form from wireless LAN is wired communication or Bluetooth. Bluetooth is a registered trademark.

The projector 2 receives video data already edited by the information processing device 1 from the information processing device 1 and stores the received video data. The projector 2 projects a video represented by the stored video data onto a screen or the like. Thus, the display of the video by the projector 2 is implemented.

The storage device 30 is a recording medium readable to the processing device 40. The storage device 30 includes, for example, a non-volatile memory and a volatile memory. The non-volatile memory is, for example, a ROM (read-only memory), EPROM (erasable programmable read-only memory), or EEPROM (electrically erasable programmable read-only memory). The volatile memory is, for example, a RAM (random-access memory).

The storage device 30 stores a program P executed by the processing device 40. The program P can also be referred to as an “application program”, “application software”, or “app”. The program P is acquired, for example, from a server or the like, not illustrated, via the com uni cat ion device 20 and is subsequently stored in the storage device 30. The program P may be stored in the storage device 30 in advance.

Also, various data referred to or generated in the course of executing the program P are in the storage device 30. A specific example of the various data referred to in the course of executing the program P is object data representing an image of an object such as a character serving as a component of a video to be projected by the projector 2. The object serving as a component of a video to be projected by the projector 2 is also referred to as a decorative part. Although not illustrated in detail in FIG. 2, one or a plurality of object data are stored in the storage device 30 in advance. The one or plurality of object data may be integrated with the program P or may be put in a library separately from the program P. A specific example of the data generated in the course of executing the program P is video data representing a video to be projected by the projector 2.

The processing device 40 includes, for example, a processor such as a CPU (central processing unit). The processing device 40 may be formed of a single processor or a plurality of processors. The processing device 40 starts executing the program P in response to an input giving an instruction to start executing the program P, performed on the touch panel 10. The processing device 40 operating according to the program P functions as a display control unit 410, an acquisition unit 420, and a decision unit 430. The display control unit 410, the acquisition unit 420, and the decision unit 430 in this embodiment are software modules implemented by causing the processing device 40 to operate according to the program P.

The display control unit 410 causes a display device of the touch panel 10 to display an editing screen for editing a video to be projected by the projector 2. The editing screen includes a video display area where an editing target image, that is, a video to be projected by the projector 2, is displayed. In this embodiment, the display control unit 410 causes the editing screen e shown in FIG. 1 to be displayed on the display surface 1a.

The editing screen e is a screen for prompting the user to perform an operation to designate an object forming an editing target video and an operation to designate an arrangement position, size, and movement of the object. As shown in FIG. 1, the editing screen e includes a first area e1, a second area e2, a virtual operator b1, and a virtual operator b2.

The first area e1 is an editing area including the video display area. The aspect ratio of the first area e1 in this embodiment is 16:9. The aspect ratio refers to the ratio of the number of pixels in the direction of the width to the number of pixels in the direction of the height of the video. When causing the display device to display the editing screen e, the display control unit 410 sets two guide lines L1 and two guide lines L2 in the first area e1, as shown in FIG. 1. The aspect ratio of the area between the two guide lines L1 in the first area e1 is 4:3. The aspect ratio of the area between the two guide lines L2 is 16:10.

Generally, in most cases, the aspect ratio of a projected video projected by a projector is one of 16:9, 16:10, and 4:3. Therefore, in this embodiment, the aspect ratio of the first area e1 is set to 16:9, whereas 16:10 is employed as a first aspect ratio and 4:3 is employed as a second aspect ratio which are different from the foregoing aspect ratio. The guide lines L1 in this embodiment are an example of first guide lines corresponding to the preset first aspect ratio. The guide lines L2 are an example of second guide lines corresponding to the second aspect ratio, which is different from the first aspect ratio. As will be described in detail later, the display control unit 410 masks an area that is different from the video display area corresponding to the aspect ratio of the projected video projected by the projector 2, in the editing area.

The second area e2 is divided into 2 by 5 cells forming a matrix. In each cell, an object corresponding to each of the one or plurality of object data stored in the storage device 30 in advance is displayed on a one-to-one basis. The object displayed in each cell serves as a candidate for a component of an editing target video. The user performs a touch operation on one of the objects displayed in the cells in the second area e2 and thus can cause the object on which the touch operation has been performed, to be displayed as a component of a video at the center of the first area e1. The user performs an operation such as touch or drag on the object displayed within the first area e1 and thus can give an instruction to enlarge or reduce, shift, or rotate the object.

The virtual operator b1 is an operator for allowing the user to give an instruction to display a preview of the video currently being edited. In response to a touch operation on the virtual operator b1, the display control unit 410 transmits the video currently displayed in the video display area to the projector 2 via the communication device 20 and thus cases the projector 2 to project this video. The video projected by the projector 2 in response to a touch operation on the virtual operator b1 is only the currently displayed video. The editing screen e is not projected by the projector 2. Based on this preview, the user can check the video to be actually projected by the projector 2 and edit the video. The virtual operator b2 is a virtual operator for allowing the user to give an instruction to generate video data representing the video currently displayed in the video display area and transmit the generated video data to the projector 2.

The acquisition unit 420 communicates with the projector 2 via the communication device 20 and acquires projector information representing the aspect ratio of a projected video, from the projector 2. More specifically, the acquisition unit 420 establishes communication connection with the projector 2 according to a predetermined communication protocol and requests the projector 2 to send back projector information. In response to the request from the acquisition unit 420, the projector 2 sends back the aspect ratio of an image generation device generating a projected video such as a liquid crystal panel to the acquisition unit 420. When an aspect ratio lower than the aspect ratio of the image generation device is set on the projector 2, the projector 2 may send back projector information representing the set aspect ratio to the acquisition unit 420.

The decision unit 430 decides the video display area, based on the aspect ratio represented by the projector information acquired by the acquisition unit 420. The display control unit 410 masks a portion that is different from the video display area decided by the decision unit 430, of the first area e1 in the editing screen e.

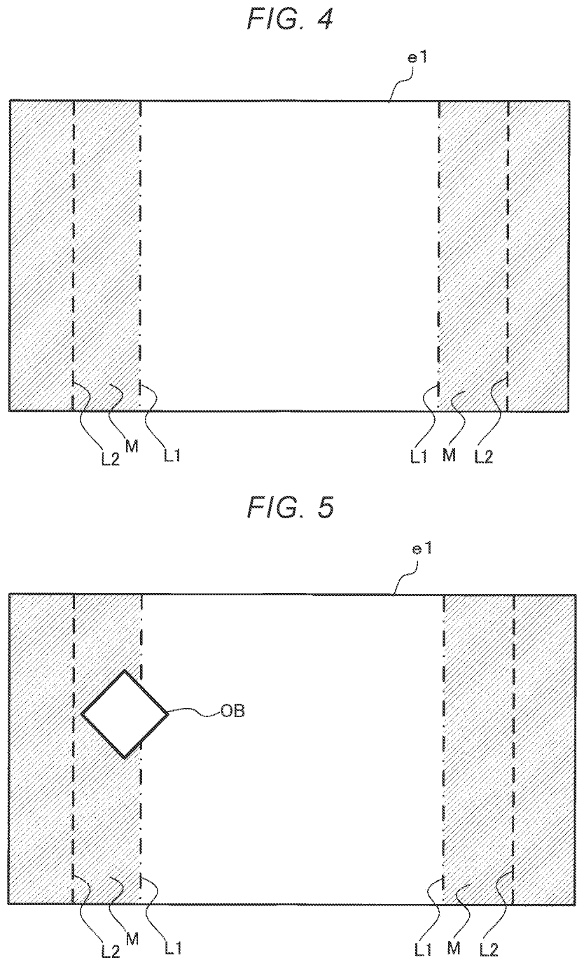

More specifically, when the aspect ratio represented by the projector information acquired by the acquisition unit 420 matches one of the aspect ratios of 16:9, 16:10, and 4:3, the decision unit 430 decides the video display area based on the matching aspect ratio. For example, when the aspect ratio represented by the projector information acquired by the acquisition unit 420 is 16:10, the decision unit 430 decides the area between the two guide lines L2 in the first area e1, as the video display area. In this case, the display control unit 410 places a mask M, as shown in FIG. 3. When the aspect ratio represented by the projector information acquired by the acquisition unit 420 is 4:3, the decision unit 430 decides the area between the two guide lines L1 in the first area e1, as the video display area. In this case, the display control unit 410 places a mask M, as shown in FIG. 4. In FIGS. 3 and 4, the mask M covering the area that is different from the video display area is hatched. When the aspect ratio represented by the projector information is 16:9, the decision unit 430 decides the entirety of the first area e1 as the video display area. In this case, the display control unit 410 sets no mask.

Meanwhile, when the aspect ratio represented by the projector information acquired by the acquisition unit 420 matches none of the aspect ratios of 16:9, 16:10, and 4:3, the decision unit 430 may decide the video display area based on the closest aspect ratio to the aspect ratio represented by the projector information, of these three aspect ratios. The decision unit 430 may also set the video display area having a shape and size corresponding to the aspect ratio represented by the projector information, in the first area e1, regardless of the guide lines L1 and the guide lines L2. For example, in the former case, when the aspect ratio represented by the projector information is 5:3, the decision unit 430 decides the area between the two guide lines L1 in the first area e1, as the video display area.

When the mask M is set in the first area e1 as shown in FIG. 3 or 4, the object designated as a component of the video and the mask may overlap each other, depending on the arrangement position of the object. In this embodiment, the display control unit 410 causes an object OB to be displayed on a foreground over the mask M in order to prevent the mask from obstructing an editing operation on the object when the object and mask overlap each other.

The information processing device 1 in this embodiment can also acquire video data edited for one projector via the communication device 20 and edit video data for another projector, based on the acquired video data. For example, when video data prepared for a projector projecting a video with an aspect ratio of 16:9 is to be edited for a projector projecting a video with an aspect ratio of 4:3, the object forming the video represented by the original video data may be located outside the video display area and overlap the mask. Even in such a case, the object is displayed on a foreground over the mask in this embodiment. Therefore, the user has no problem in performing an editing operation such as moving the object into the video display area.

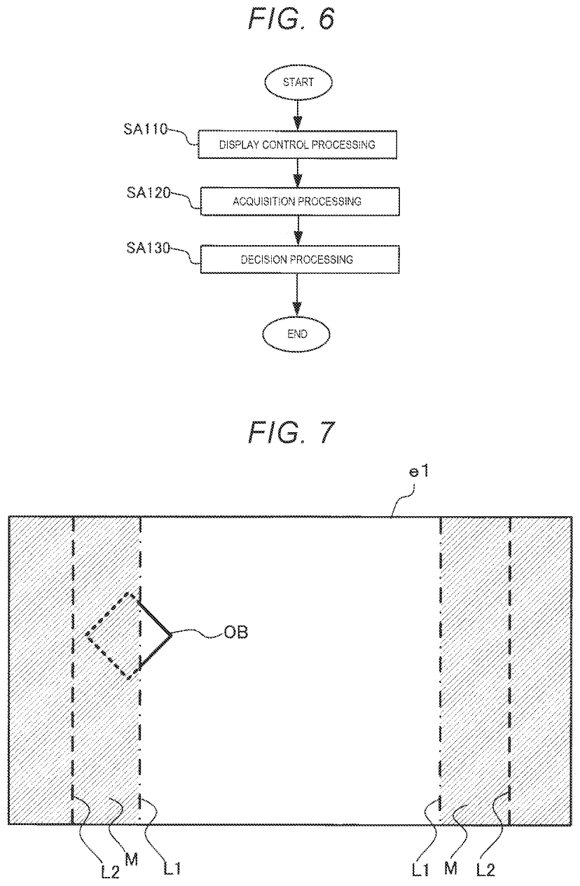

The processing device 40 operating according to the program P executes the control method according to the present disclosure. FIG. 6 is a flowchart showing the flow of the control method executed by the processing device 40 according to the program P. As shown in FIG. 6, the control method according to the present disclosure includes display control processing SA110, acquisition processing SA120, and decision processing SA130.

In the display control processing SA110, the processing device 40 functions as the display control unit 410. In the display control processing SA110, the processing device 40 causes the display device of the touch panel 10 to display the editing screen e where the guide lines L1 and the guide lines L2 have already been set in the first area e1, as shown in FIG. 1. In the acquisition processing SA120, the processing device 40 functions as the acquisition unit 420. In the acquisition processing SA120, the processing device 40 communicates with the projector 2 via the communication device 20 and acquires projector information. In the decision processing SA130, the processing device 40 functions as the decision unit 430 and the display control unit 410. In the decision processing SA130, the processing device 40 decides the video display area based on the aspect ratio represented by the projector information acquired in the acquisition processing SA120 and masks a part that is different from the video display area, of the first area e1.

When projector information representing an aspect ratio of 16:10 is acquired from the projector 2 in the acquisition processing SA120, the area between the two guide lines L2 in the first area e1 is decided as the video display area and the mask M is set as shown in FIG. 3 in the decision processing SA130. When projector information representing an aspect ratio of 4:3 is acquired from the projector 2 in the acquisition processing SA120, the area between the two guide lines L1 in the first area e1 is decided as the video display area and the mask M is set as shown in FIG. 4 in the decision processing SA130. When projector information representing an aspect ratio of 16:9 is acquired from the projector 2 in the acquisition processing SA120, the entirety of the first area e1 is decided as the video display area and no mask is set in the decision processing SA130.

As described above, the information processing device 1 according to this embodiment enables the user to edit a video while checking the video with an aspect ratio actually projected by the projector 2. Therefore, the occurrence of the situation where the projected video projected by the projector 2 is not as intended by the user can be avoided.

### 2. Modification Examples

The foregoing embodiment may be suitably combined with the modifications described below.

(1) In the embodiment, the editing screen e where the guide lines L1 corresponding to the preset first aspect ratio and the guide lines L2 corresponding to the second aspect ratio that is different from the first aspect ratio have already been set is displayed at the display device of the touch panel 10. However, the setting of the guide lines L1 and the guide lines L2 may be omitted. This is because, even when the guide lines L1 and the guide lines L2 are not provided, the user can grasp the video actually projected by the projector 2, based on the display content in the video display area. In the first embodiment, the mask is set by the display control unit 410 at the portion that is different from the video display area decided by the decision unit 430, of the first area e1. However, the aspect ratio of the projector 2 may be achieved by changing the shape and size of the first area e1 instead of setting the mask.

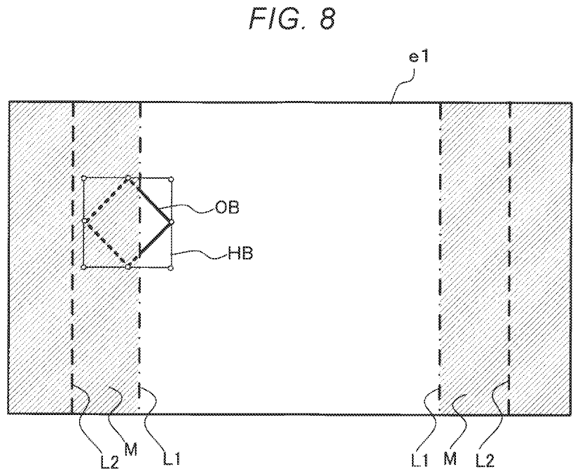

(2) In the embodiment, when the object and the mask overlap each other, the object included in the editing target video is displayed on a foreground over the mask. However, when a part of the object OB included in the editing target video overlaps the mask M, as shown in FIG. 7, the object OB may be displayed with the part being in a different display state from a portion that is different from the part, of the object OB, so as to accept a touch operation or the like on the part. A specific example of the different display state may be a semitransparent display or that the contour of the object is indicated by a dotted line, or the like. The example shown in FIG. 7 employs the latter configuration. Also, when the object OB is displayed along with an operation frame HB for accepting a user's operation on the object included in the editing target video and the object OB and the mask M overlap each other, as shown in FIG. 8, the mask M is may be displayed on a foreground over the object OB and the operation frame HB may be displayed as a foregoing over the mask M. The operation frame HB in FIG. 8 is also referred to as a capture box. The configuration shown in FIG. 7 or 8, too, enables the user to perform, without any problem, an editing operation on the object partly protruding out of the video display area and overlapping the mask.

(3) In the embodiment, the program P causing the processing device 40 to function as the display control unit 410, the acquisition unit 420, and the decision unit 430 is already stored in the storage device 30. However, the program P may be manufactured or distributed as it is. A specific method for distributing the program P may be writing the program in a computer-readable recording medium such as a flash ROM (read-only memory) and distributing the program in this form, or downloading the program via an telecommunications network such as the internet and distributing the program. Installing the program in a general information processing device and causing the computer of the information processing device to operate according to the program enables this information processing device to function as the information processing device 1 according to the embodiment.

(4) In the embodiment, the display control unit 410, the acquisition unit 420, and the decision unit 430 in the embodiment are software modules implemented by causing the processing device 40 to operate according to the program P. However, a part or all of the display control unit 410, the acquisition unit 420, and the decision unit 430 may be hardware. An example of this hardware is a DSP (digital signal processor), ASIC (application-specific integrated circuit), PLD (programmable logic device), and FPGA (field-programmable gate array). Even when a part or all of the display control unit 410, the acquisition unit 420, and the decision unit 430 are hardware, the same effect as in the embodiment is achieved.

(5) In the embodiment, the information processing device 1 functions as a video editing device editing a video to be projected by the projector 2. However, a video editing device having the display control unit 410, the acquisition unit 420, and the decision unit 430 may be manufactured or sold as it is. Incorporating this video editing device into a general information processing device enables this information processing device to function as the information processing device 1 according to the embodiment. Also, the video editing device may be incorporated in a projector communicating with an information processing device via a wireless LAN or the like. In this case, the video editing device incorporated in the projector communicates with the information processing device via the wireless LAN and causes the information processing device to display the editing screen e on the display surface. The video editing device incorporated in the projector acquires projector information via an internal bus or the like and decides the video editing area in the editing screen e, based on the aspect ratio represented by the projector information. An operation performed on the editing screen e is communicated from the information processing device to the video editing device in the projector via the wireless LAN. The video editing device edits the video data, based on the operation communicated from the information processing device.

### 3. Configuration Grasped From at Least One of Embodiment and Modification Examples

The present disclosure is not limited to the foregoing embodiment and modification examples and can be implemented in various other configurations without departing from the spirit and scope of the present disclosure. For example, the present disclosure can be implemented in the configurations described below. A technical feature in the embodiment corresponding to a technical feature in each of the configurations described below can be suitably replaced or combined with another technical feature in order to solve a part or all of the problems of the present disclosure or in order to achieve a part or all of the effects of the present disclosure. The technical feature can be suitably deleted unless described as essential in this specification.

As one configuration of the method for controlling a video editing device according to the present disclosure, a method for controlling a video editing device editing a video to be projected by a projector includes display control processing, acquisition processing, and decision processing, described below. In the display control processing, an editing screen including a video display area where an editing target video is displayed, is displayed. In the acquisition processing, information representing an aspect ratio of a projected video projected by the projector is acquired from the projector. In the decision processing, the video display area is decided according to the aspect ratio represented by the information. This configuration enables the user to edit a video while checking the video having the aspect ratio actually outputted from the projector and therefore to have an output result as intended.

In one configuration of the control method, the editing screen may include an editing area including the video display area. In the display control processing, the editing screen where a first guide line representing a preset first aspect ratio and a second guide line representing a second aspect ratio that is different from the first aspect ratio are already set in the editing area may be displayed. According to this configuration, the user editing a video to be projected by the projector, with the video editing device, can experience the first aspect ratio via the first guide line and can also experience the second aspect ratio via the second guide line.

In one configuration of the control method, in the decision processing, a mask may be placed on an area that is different from the video display area, in the editing area. According to this configuration, the user editing a video to be projected by the projector, with the video editing device, can experience the aspect ratio of the projected video projected from the projector, based on the way the mask is set.

In one configuration of the control method, when a part of an object included in the editing target video overlaps the mask, the object may be displayed with the part being in a different display state from a portion that is different from the part. According to this configuration, the user editing a video to be projected by the projector, with the video editing device, can grasp an object included in the editing target video and partly protruding out of the video display area and can perform an editing operation on the object.

In one configuration of the control method, an object included in the editing target video may be displayed along with an operation frame for accepting a user's operation on the object When the object overlaps the mask, the mask may be displayed on a foreground over the object and the operation frame may be displayed on a foreground over the mask. According to this configuration, the user editing a video to be projected by the projector, with the video editing device, can grasp an object included in the editing target video and partly protruding out of the video display area and can perform an editing operation on the object.

In one configuration of the control method, when the object overlaps the mask, the object included in the editing target video may be displayed on a foreground over the mask. According to this configuration, the user editing a video to be projected by the projector, with the video editing device, can grasp an object included in the editing target video and partly protruding out of the video display area and can perform an editing operation on the object.

As one configuration of the video editing device according to the present disclosure, a video editing device includes a display control unit, an acquisition unit, and a decision unit, described below. The display control unit causes an editing screen to be displayed, the editing screen including a video display area where a video to be projected by a projector is displayed. The acquisition unit acquires, from the projector, information representing an aspect ratio of a projected video projected by the projector. The decision unit decides the video display area according to the aspect ratio represented by the information acquired by the acquisition unit. This configuration, too, enables the user to edit a video while checking the video having the aspect ratio actually outputted from the projector and therefore to have an output result as intended.

As one configuration of the program according to the present disclosure, a program causes a computer to function as a display control unit, an acquisition unit, and a decision unit. The display control unit causes an editing screen to be displayed, the editing screen including a video display area where a video to be projected by a projector is displayed. The acquisition unit acquires, from the projector, information representing an aspect ratio of a projected video projected by the projector. The decision unit decides the video display area according to the aspect ratio represented by the information acquired by the acquisition unit. This configuration, too, enables the user to edit a video while checking the video having the aspect ratio actually outputted from the projector and therefore to have an output result as intended.

What is claimed is:

1. A method for controlling a video editing device editing a video to be projected by a projector, the method comprising:
displaying an editing screen including a video display area where an editing target video is displayed;
acquiring, from the projector, information representing an aspect ratio of a projected video projected by the projector; and
deciding the video display area according to the aspect ratio represented by the information.

2. The control method according to claim 1, wherein
the editing screen includes an editing area including the video display area, and
the editing screen where a first guide line representing a preset first aspect ratio and a second guide line representing a second aspect ratio that is different from the first aspect ratio are already set in the editing area is displayed.

3. The control method according to claim 2, wherein
a mask is placed on an area that is different from the video display area, in the editing area.

4. The control method according to claim 3, wherein
when a part of an object included in the editing target video overlaps the mask, the object is displayed with the part being in a different display state from a portion that is different from the part.

5. The control method according to claim 3, wherein
an object included in the editing target video is displayed along with an operation frame for accepting a user's operation on the object, and when the object overlaps the mask, the mask is displayed on a foreground over the object and the operation frame is displayed on a foreground over the mask.

6. The control method according to claim 4, wherein
when the object overlaps the mask, the object included in the editing target video is displayed on a foreground over the mask.

7. A video editing device comprising:
a display control unit causing an editing screen to be displayed, the editing screen including a video display area where a video to be projected by a projector is displayed;
an acquisition unit acquiring, from the projector, information representing an aspect ratio of a projected video projected by the projector; and
a decision unit deciding the video display area according to the aspect ratio represented by the information acquired by the acquisition unit.

8. A non-transitory computer-readable storage medium storing a program, the program causing a computer to function as:
a display control unit causing an editing screen to be displayed, the editing screen including a video display area where a video to be projected by a projector is displayed;
an acquisition unit acquiring, from the projector, information representing an aspect ratio of a projected video projected by the projector; and
a decision unit deciding the video display area according to the aspect ratio represented by the information acquired by the acquisition unit.
